(19) United States
(12) Patent Application Publication
(10) Pub. No.: US 2008/0238710 A1
(43) Pub. Date: Oct. 2, 2008

(54) system and method for demand dispatch and load management

(76) Inventors: Jeff Tolnar, Columbus, OH (US); Heidi Caroline, Meadville, PA (US); Larry Hymer, Columbus, OH (US); Michael Bauer, San Francisco, CA (US)

Correspondence Address: BUCHANAN, INGERSOLL & ROONEY PC, POST OFFICE BOX 1404, ALEXANDRIA, VA, 22313-1404, US

(21) Appl. No.: 12/076,858

(22) Filed: Mar. 24, 2008

Related U.S. Application Data
(60) Provisional application No. 60/907,185, filed on Mar. 23, 2007.

(51) Int. Cl. G08C 19/16

(52) U.S. Cl. 340/870.01

(57) ABSTRACT

Provided is a system and method for monitoring utilization of a resource across an entire distribution area. The system dynamically and intelligently limits the aggregated utilization of the resource across an entire distribution area or targeted sub areas. Targeted usage thresholds at the device (individual utilization) level, as well as utility-specified business and technical rules and overrides, can be applied. Using these rules, the system continuously looks for and manages individual utilization of the resource that is available for curtailment, thus producing a larger and more efficient utilization level that is available for reduction without service impact to customers within that service area or targeted sub areas.

### PRIORITY STATEMENT

This disclosure claims the benefit of prior Provisional Application No. 60/907,185 filed on Mar. 23, 2007, which is hereby incorporated by reference in its entirety.

### FIELD

This invention relates generally to systems and methods of governing an aggregated utilization of a resource and to manage the supply and demand of the resource.

### BACKGROUND OF THE INVENTION

Management of generation and distribution of a resource is highly desirable. This is especially true in the distribution of utility resources such as electricity, gas, and water. In the case of electricity distribution, cost of acquiring capacity to meet peak demand, such as building new power plants, can be enormous. This cost is usually passed on to the customers in the form of higher electric bills. Also, acquiring additional capacity has other costs such as environmental impacts due to increased emission of pollutants. Further, significant regulatory hurdles exist that delay the implementation of new power plants.

The utilities can also purchase energy from other power producers during peak demand. However, wholesale costs of electricity are highest during peak demand. These costs may not be passed on to the consumers or may be only partially passed on for various reasons, which erodes the profitability of utilities. Also, when a utility elects to purchase peak energy to meet growing demand, the increased demand can exceed the design parameters of transmission/distribution substations and circuits. In this situation, additional capital is required to upgrade the power delivery infrastructure to meet growth in demand. Some or all of these upgrades may require regulatory approval, and/or encounter lengthy delays.

Further, the assets of the utilities (e.g., distribution lines, transformers, feeders, and underground cables) deteriorate more quickly if they are operated over some specified tolerance limits. For example, overstressed transformers may quickly blow and cease to operate, which disrupts power to many customers. In most instances, the utility is notified of the disruption only when complaints are registered by the customers. In addition, costs associated with repairing equipment can be significant.

### SUMMARY OF THE INVENTION

A system and method of exemplary embodiments monitor utilization of a resource across an entire distribution area. The system dynamically and intelligently limits the aggregated utilization of the resource across an entire distribution area or targeted sub areas.

According to exemplary embodiments, a method of managing utilization and distribution of a utility resource may comprise monitoring condition parameters of individual customer premises that pertain to utilization of the resource to obtain respective condition values, storing the obtained condition values in a database by ID of the customer premise and storing predefined service parameters of respective customer premises, and controlling utilization of the resource by devices located at the customer premises based on predefined priority parameters, the condition values, and the predefined service parameters.

The condition values may include at least one of temperature, internal ambient temperature, device state, device voltage, device current, power factor, and load profile. The predefined priority parameters may be based on at least one of the type of device, customer priority, and customer preferences. The predefined service parameters may include at least one of physical address, customer preferences, customer shed priority, and device priority.

The monitoring of the condition parameters may be performed by using premise sensors and premise controllers. The premise sensors are configured to detect the condition values of the respective devices and the premise controllers are associated with the respective devices. Based on the data from the premise sensors, the premise controllers are operated to reduce utilization of the resource by the respective devices.

A maximum level of system demand across an entire resource distribution grid, subareas within the grid, or individual customer premises may be established. When the utilization of the resource reaches the maximum level of system demand, a cumulative total of the utilization by all devices that are running are calculated and a desired utilization level is compared with the running cumulative total to obtain a desired reduction amount. A curtailment in utilization of the resource is initiated if the desired utilization level is lower than the running cumulative total.

Groups of devices whose total utilization of the resource matches the desired reduction amount may be created according to priority. A command may be sent to the premise controller of the group having the lowest priority to signal the premise controller to open a relay and interrupt delivery of the resource to the respective device. The curtailment in utilization of the resource is implemented from lowest priority to highest priority until the curtailment in utilization is satisfied.

Using these rules, the system continuously looks for and manages individual utilization of the resource that is available for curtailment, thus producing a larger and more efficient aggregate utilization level that is available to shed without service impact to customers within that service area or targeted sub areas. In one embodiment, a centralized software program (demand dispatch software) is used to dynamically and intelligently limit the utilization of the resource.

Exemplary embodiments of the system and method may provide many benefits while meeting the utilization demands. These benefits include reducing operational risks. In the electricity distribution industry, the operational risks that can be reduced include risk of rolling blackouts, profit risk due to volatility of energy feedstock, risk to assets from overload conditions, risks to customers from outages, and risk to the environment from CO₂ and other emissions.

### BRIEF DESCRIPTION OF THE DRAWINGS

Exemplary embodiments will be more clearly understood from the following detailed description taken in conjunction with the accompanying drawings. FIGS. 1-3 represent non-limiting, exemplary embodiments as described herein.

FIG. 1 is a diagram illustrating the Demand Dispatch and Load Management System according to exemplary embodiments.

FIG. 2 is a diagram illustrating a communications network of the Demand Dispatch and Load Management System according to exemplary embodiments.

FIG. 3 is a flow chart illustrating a method of managing utilization and distribution of a utility resource according to exemplary embodiments.

### DETAILED DESCRIPTION OF THE INVENTION

For simplicity and illustrative purposes, the principles of the invention are described by referring mainly to exemplary embodiments thereof. However, one of ordinary skill in the art would readily recognize that the same principles are equally applicable to many types of demand dispatching and load management.

An embodiment of the invention involves a software program and hardware control system that can govern the aggregated utilization of a resource in a distribution service area. The controlled service area can be as broad as a utility's entire distribution network or as specific as individual customer premises. The software program may use configurable rules to manage individual utilization of the resource at the customer premise via a circuit controller and a communications network. Information regarding the individual utilization of the resource is fed back to the system (e.g., a central database) through the communications network. The software program can use algorithms to manage this information once the information is returned to meet system prescribed utilization curtailment objectives.

Electricity resource distribution examples are used to illustrate the principles of the invention below. However, the invention is not so limited. Management of other utility resources such as gas and water distribution fall under the scope of the invention. In addition, the invention is not limited to utility types of resources. The invention is applicable to many situations in which it is desired to manage distribution of a resource.

In an embodiment of the invention, a centralized software program is used to dynamically and intelligently limit the aggregated utilization of a resource across an entire distribution area or targeted sub areas by applying customer designated usage thresholds at the device (individual utilization) level, as well as utility-specified business and technical rules and overrides. Using these rules, the system and/or method can continuously look for and manage individual utilization of the resource that is available for curtailment, thus producing a larger and more efficient utilization level that is available to shed while minimizing or eliminating service impact to customers within that service area or within the targeted sub areas.

The software program/hardware can manage the entire resource distribution grid as a whole, individual areas within the grid, subareas within individual areas, and individual premises and devices (e.g., appliances). It should be noted that many levels of hierarchy fall under the scope of the embodiments of the present invention.

Systems and methods of exemplary embodiments provide the resource utility with the direct utilization control tools necessary to avoid purchasing the resource at peak wholesale prices. The utility manages measured utilization curtailment across the entire distribution footprint based on its overall load clipping requirements. Exemplary embodiments allow the utility to aggregate utilization of the resource across its entire grid and distribute the curtailment of the resource across the entire customer base in smaller increments in order to maintain program comfort thresholds and prices, or curtail usage in larger increments in order to maintain the integrity of the resource distribution grid.

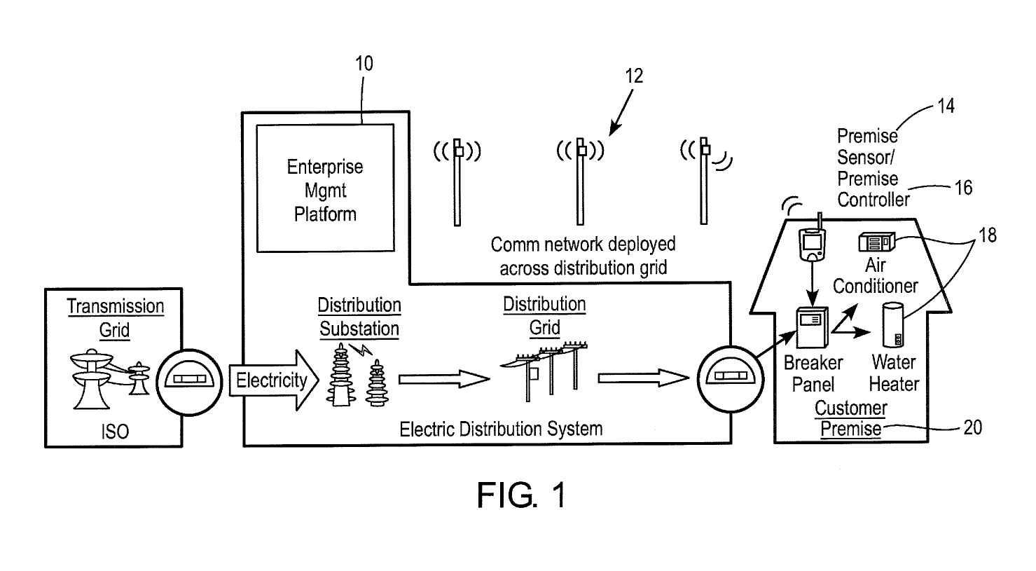

Referring to FIG. 1, an embodiment of the system may include an enterprise management platform 10, communications system 12, premise sensors 14, and premise controllers 16. The enterprise management platform 10 can monitor customer premise conditions (e.g., temperature and load), store all information related to usage programs by each customer premise 20, send dispatch instructions to premise controllers 16, and manage communications. The communications between the enterprise management platform 10 and the premise controllers 16 and sensors 14 can occur in a variety of ways including via broadband connections in a mesh network. These connections can be fiber, wireless, power line, or other broadband technology.

Premise controllers 16 are placed into every participating customer premise 20. The premise controllers 16 and premise sensors 14 communicate with the enterprise management platform 10 over the communications system 12.

The enterprise management platform 10 may be a centralized combination of software program, hardware, and database system that monitors actual resource utilization and demand, as well as the state of the devices of the system. The enterprise management platform 10 distributes the utilization of the resource to achieve specified purposes including maintaining the integrity of the distribution system, minimizing purchase costs, and minimizing impact to end customers.

To monitor and control the distribution of the resource, premise sensors 14 and premise controllers 16 are employed. Premise sensors 14 are located proximately or otherwise as necessary to detect the operations of individual devices 18 (e.g., air conditioner, water heater, etc.). In one example, the premise sensors 14 may be placed on or be integrated with the devices 18.

These premise sensors 14 are configured to detect parameters of interest for the device 18. For example, if the device 18 is a thermal appliance such as a water heater, the corresponding premise sensor 14 can be configured to detect water temperature, and internal ambient temperature, voltage, and current levels of the water heater. The state of the device 18 (e.g., on/off, power factor, and load profile) can be detected. As another example, if the device 18 to be controlled is a pool pump, the water level of the pool or the pH level may be of interest.

Premise sensors 14 may also be placed at individual customer premises 20 to monitor conditions pertinent to the operation of the controlled load at the premises. For example, a premise sensor 14 may be used to detect the ambient temperature of a customer's house or building. This information aids in determining whether HVAC for the customer premise 20 will be controlled or not.

When a situation occurs such that resource utilization needs to be curtailed, premise controllers 16 can be operated to reduce demand based on priorities without significant impact on the customer. For example, the water heater can be powered off for a short period of time, for example, 30 minutes, without significantly affecting the water temperature. As another example, it may be tolerable to allow the temperature of the house or building to be at a certain temperature, for example, 78° F. during the summer or 70° F. during the winter. In this instance, it may be acceptable to power off the air conditioner (or heater) when the temperature is within tolerable limits. As yet another example, pool pumps need not be operated constantly. Thus, when peak demand occurs, these “non-essential” devices may be cycled to curtail the utilization of the electrical resource to acceptable levels. In other words, the system intelligently manages the utilization of the resource based not only on the amount of resource utilization, but also on the type of the devices utilizing the resource.

The priorities of the controlled devices may change dynamically. For example, the air conditioner (or heater) may be turned on so that the building environment is kept within tolerable limits. Exemplary embodiments of the system take into account such dynamic factors.

It is to be noted that the premise sensors 14 and premise controllers 16 work cooperatively. That is, based on the data from the premise sensors 14, the premise controllers 16 are operated to efficiently curtail utilization of the resource. The premise sensors 14 and the premise controllers 16 may be integrated or may be otherwise configured to work cooperatively with each other.

In an embodiment of the present invention, the communications system provides two-way communications between the customer premises 20, targeted areas, and the enterprise management platform 10. The granularity may be such that each individual premise sensor 14 and premise controller 16 are controlled by the enterprise management platform 10.

The premise controllers 16 may be controlled wirelessly via radio signals. Similarly, the premise sensors 14 may transmit their sensor data wirelessly as well. The transmission of wireless signals can be performed directly between the premise controllers 16 and the premise sensors 14 and the enterprise management platform 10.

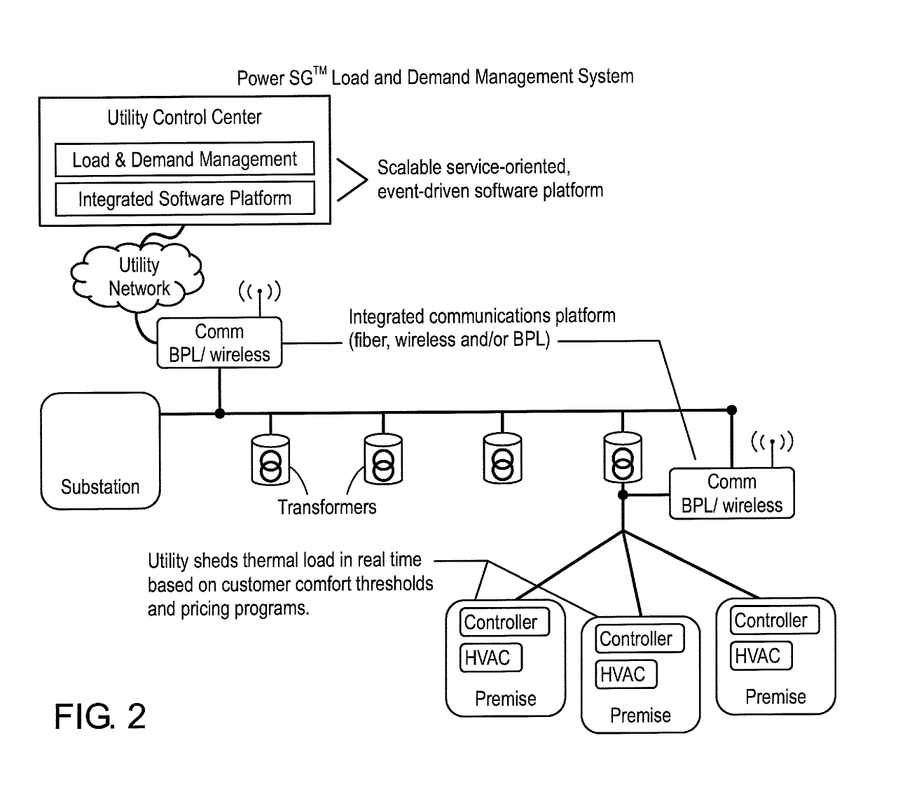

While direct communication is possible as described above, such configuration may limit the range of communication. Thus, referring to FIG. 2, a communication backbone and communication aggregators can be provided to increase the communications range and to enhance reliability. The premise controllers 16 and premise sensors 14 may be grouped and an aggregator can be provided to communicate for each group. The premise controllers 16 and premise sensors 14 of each group may communicate with the enterprise management platform 10 via the aggregator for the group.

The communication between the premise controllers 16, the premise sensors 14, and the aggregator can be accomplished through known communication formats (e.g., CDMA, GSM, and WiFi). The premise controllers 16 and premise sensors 14 may also communicate with the aggregator via power lines, for which there are known communication formats. Other examples include optical and copper lines.

Further, the aggregators themselves can also utilize a communications backbone to communicate with the enterprise management platform 10. Again, known communication formats, for example, Ethernet, BPL, dedicated point-to-point (T1 or frame relay), iDen Wireless, CDMA Wireless, GPRS Wireless, WiFi, and WiMax, are available to facilitate this communication.

The enterprise management platform 10 continuously monitors conditions of customer premises 20 and system resource utilization throughout the deployed area on a load by load basis. The communication can occur through an IP based network with remotely located concentrator devices or aggregators. The aggregators may connect to the premise controllers 16 through 900 MHz radio or PLC/BPL links or by other communication means. The premise controllers 16 and the premise sensors 16 interact with the aggregators, sending asynchronous messages of condition changes at the customer premises 20. The condition changes that are monitored can include internal ambient temperature, voltage and current levels of the device being controlled, and the state of the device being controlled (e.g., on/off, power factor, and load profile).

The enterprise management platform 10 can manage the measured utilization of the resource based upon pre-established criteria or thresholds that the utility (or load management company) monitors and controls. For peak shedding, the technology can be applied at several levels. System demand limiting functions allow the utility to select a maximum level of system demand, either across the utility's entire resource distribution grid, in specific sections of the resource distribution grid, or down to the individual transformer or specific customer premises 20. Demand can be limited by managing customer premises utilization for the participating customer base, or in critical situations, resource curtailment can be applied across all customer premises 20 to avoid blackout conditions.

Current resource utilization can be incrementally and dynamically cycled while customer premises conditions are continuously monitored. Resource cycling may be granular with specific service level agreements established for each customer premises 20 based upon customer or utility specified upper and lower set points. These set points can be constantly monitored by the central system and cycling can be performed at either the individual device level, for the entire load area, or at any level in between.

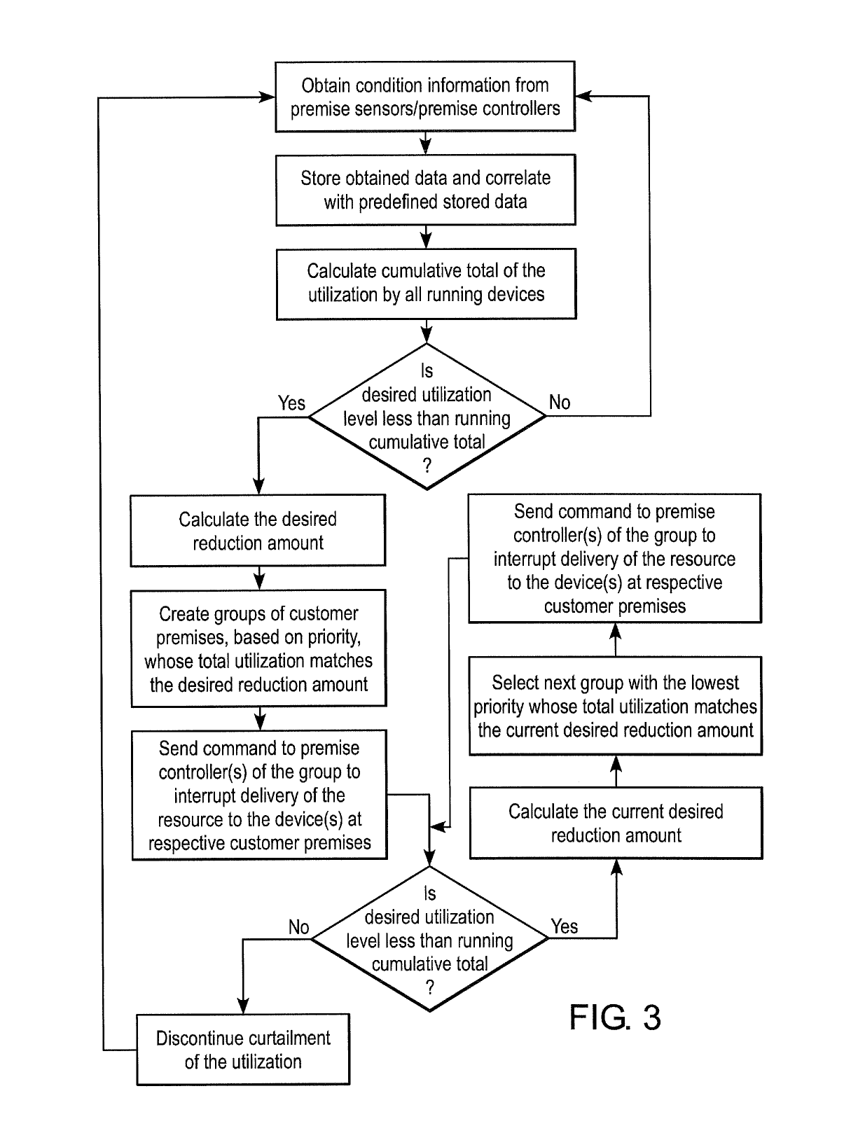

In reference to FIG. 3, an algorithm implemented in a system of exemplary embodiments is described below. The enterprise management platform 10 maintains a system wide inventory of resource utilization by customer premises 20. This can be accomplished by having the system poll all of the premise controllers 16 and premise sensors 14 periodically (e.g., every 5 minutes) to gather information, for example, ambient temperature, controlled device state (on/off, and controlled device voltage and current. Alternatively, the premise controllers 16 and premise sensors 14 can report periodically to the enterprise management platform 10 without being polled. A combination of polling and self-reporting also fall within the scope of the embodiments of the present invention.

The obtained data is placed in a database on the enterprise management platform 10, listing the premise controller ID and the obtained data, for example, the ambient temperature, device state (on/off), and the status of the voltage and current. This data can then be correlated with stored information in the database (e.g., physical address, customer temperature preference, and customer shed priority).

When the enterprise management platform 10 calls for a curtailment in resource utilization, the system can start shedding resource usage based on predefined parameters of device priority, customer priority, and customer preference. The system calculates a cumulative total of the utilization by all devices that are running and compares a desired utilization level with the running cumulative total to obtain a desired reduction amount. A curtailment in utilization of the resource is initiated if the desired utilization level is lower than the running cumulative total.

The system can create groups of customer premises, based on priority, whose total resource utilization adds up to the desired reduction amount within the individual service level parameters. A group may have as few as one device as a member. When these groups have been set up, the system sends commands to the respective premise controller 16 of the group to signal the controller to open a relay and interrupt the delivery of the resource to the controlled device. The premise controller 16 sends a time stamped response to the system to notify that the delivery of the resource to the device 18 has indeed been interrupted, including a current measurement reading verifying that the current is now zero. By comparing this change of state to the previous utilization of the resource by the device 18, the system can determine exactly how much of the resource utilization was curtailed and when.

The system may continuously monitor the resource utilization that is required to be curtailed, the current resource utilization, and the individual service level parameters. When a device 18 reaches its predefined time or temperature service level parameter, for example, the system may send a command to the respective premise controller 16 of the group to signal the controller to restore delivery of the resource to the interrupted controlled device 18.

The system selects the next group whose total resource consumption matches the current desired reduction amount. Commands can then be sent to that set of premise controllers 16. Thus, the curtailment of the utilization of the resource is dynamically rotated among the entire managed distribution area based on utility specified device priority, customer priority, and customer preference. This process continues until the resource distribution area no longer needs the curtailment.

Priorities may be specified by a number of factors including the type of the device 18 (e.g., HVAC, water heater, and pool pump), past load profile, customer priority, customer type, and customer preferences. The controlled device can represent anything at the customer premises 20 that consumes the resource. The utility can set a priority of when certain devices are considered for demand curtailment and set a priority to each device 18. The system may systematically group each device 18 into the priority specified and shed from lowest priority to highest priority until the demand curtailment is satisfied.

The utility may also set a priority of customers based on the amount of time their devices have been manipulated and/or the amount of time the resource has not been supplied to the customer, which may be utility specified criteria. Further, priority may be set by customer preferences (e.g., monthly budget limits and ambient house temperature), which interact with the device priority that the utility has specified.

For example, if the desired level of demand curtailment cannot be achieved by interrupting other controlled devices 18, the system may look to the A/C compressors. As before, the enterprise management platform 10 may produce a cumulative total of possible demand curtailment using resource utilization by the A/C compressors. In addition to the resource utilization by the A/C compressor load, the system may measure the temperature in the customer premises 20, which is periodically collected and stored by polls of the premise sensor 14, and compare it with the customer's threshold temperature, in conjunction with a demand management system component of the enterprise management platform 10. The demand management system can be implemented in software. If the current temperature in the customer premises 20 is greater than a preset temperature parameter (e.g., 3 degrees cooler than the threshold temperature), a command can be sent to the premise controller 16 to interrupt the compressor and eliminate the demand.

In all cases, the interruption of an A/C compressor may continue until the threshold temperature is reached, at which time control is released to the local thermostat by ordering the premise controller 16 to close the relay. When control is released to the local thermostat, the system may select the next running A/C compressor whose customer premises 20 temperature is greater than 3 degrees below the threshold temperature. If threshold limits are set, for example, at a target of 75° Fahrenheit, customers will not feel a loss of comfort or a loss of total power. Management of other loads may be accomplished in much the same way as with AC compressor control.

As the system peak demand falls, fewer and fewer interruptions are required until eventually all of the load can be restored to normal operation. This may be constantly communicated between the utility's central load dispatcher and the enterprise management platform 10 by updating the amount of resource utilization that must be dispatched. In an embodiment, the enterprise management platform 10 interfaces with the central load dispatcher to receive requests to curtail utilization of the resource. The enterprise management platform 10 automatically reports back where the resource utilization was curtailed and when.

As an alternative, load reduction may be achieved by synchronizing AC cycles. For example, under conditions when the average AC unit cycles on for 30 minutes per hour, the enterprise management platform 10 manages duty cycles in such a manner at each time, only half of all AC units are cycled on, and the other half is cycled off. This approach allows substantial load shed compared to de-synchronized operation, where duty cycles of a large percentage of AC units may overlap, leading to a large load spike.

As an alternative, a controller may be managed via a number of different communications scenarios including 900 MHz, WiFi, licensed wireless spectrum, and BPL. The base load management technology may also be incorporated as a front end into other distributed and micro-generation products to extend their useful life. Instead of a centralized software system, similar functionality may also be achieved by a system of software program agents, resident in controllers and other parts of the system, that would negotiate allowable resource usage per each device on an ongoing basis. There may be preference for a method/system of overarching mediation and control deployed with this scenario. Otherwise, it could be similar to a blind load shed.

The embodiments of the present invention allow for more efficient operation of resource utilization management. This more efficient operation reduces costs, protects assets, increases reliability, reduces the need for reserve capacity (such as spinning reserve), and reduces maintenance requirements.

Premise controllers and premise sensors allow control of individual devices at the respective customer premises. However, the demand dispatch and load management is also applicable to controlling assets of the utilities as well. For example, sensors and controllers can be used to monitor devices, including transformers and feeders, without departing from the scope of the invention.

It will be appreciated by those skilled in the art that the present invention can be embodied in other specific forms without departing from the spirit or essential characteristics thereof. The presently disclosed embodiments are therefore considered in all respects to be illustrative and not restricted thereto.

What is claimed is:

1. A method of managing utilization and distribution of a utility resource, the method comprising:
monitoring condition parameters of individual customer premises that pertain to utilization of said resource, to obtain respective condition values;
storing the obtained condition values in a database by ID of the customer premises and storing predefined service parameters of respective customer premises; and
controlling utilization of said resource by devices located at the customer premises based on predefined priority parameters, the condition values, and the predefined service parameters.

2. The method of claim 1, wherein the condition values include at least one of temperature, internal ambient temperature, device state, device voltage, device current, power factor, and resource utilization profile.

3. The method of claim 2, wherein the devices are categorized into different types and the condition parameters depend on the type of the device.

4. The method of claim 1, wherein the predefined priority parameters are based on at least one of type of device, customer priority, and customer preferences.

5. The method of claim 1, wherein the predefined service parameters include at least one of physical address, customer preferences, customer shed priority, and device priority.

6. The method of claim 1, wherein the monitoring is performed by using premise sensors and premise controllers, the premise sensors being configured to detect the condition values of respective devices and the premise controllers being associated with respective devices.

7. The method of claim 6, wherein the premise sensors and the premise controllers are configured to work cooperatively with each other.

8. The method of claim 7, wherein the premise sensors and the premise controllers are integrated.

9. The method of claim 6, wherein based on data from the premise sensors, the premise controllers are operated to reduce utilization of said resource by respective devices.

10. The method of claim 6, further comprising:
obtaining the condition values by polling the premise sensors.

11. The method of claim 6, wherein the sensors autonomously transmit the condition values.

12. The method of claim 1, wherein the obtained condition values are correlated with the predefined service parameters.

13. The method of claim 1, further comprising:
establishing a maximum level of resource demand across an entire resource distribution grid, subareas within the grid, or individual customer premises.

14. The method of claim 13, wherein when the utilization of said resource reaches the maximum level of system demand, a cumulative total of the utilization by all devices that are running is calculated and a desired utilization level is compared with the running cumulative total to obtain a desired reduction amount, a curtailment in utilization of said resource being initiated if the desired utilization level is lower than the running cumulative total.

15. The method of claim 14, further comprising:
establishing priority levels for the individual customer premises; and
selectively controlling the devices at the customer premises based upon the priority level.

16. The method of claim 15, further comprising:
creating groups of devices, according to their priority level, whose total utilization of said resource matches the desired reduction amount; and
sending a command to each premise controller of the group with the lowest priority level to signal the premise controller to interrupt delivery of said resource to the respective device.

17. The method of claim 16, wherein a subsequent group with the next lowest priority level is selected and a command is sent to each premise controller of the group to signal the premise controller to interrupt delivery of said resource to the respective device, the curtailment in utilization of said resource being implemented from lowest priority level to highest priority level until the curtailment in utilization is satisfied.

18. The method of claim 16, wherein each group includes at least one device as a member.

19. The method of claim 16, wherein the premise controller sends a time stamped response to notify that the delivery of said resource to the device has been interrupted.

20. The method of claim 19, wherein the amount of the utilization of said resource that was curtailed is determined by comparing the change of state of the device to the previous utilization of said resource by the device.

21. The method of claim 14, further comprising:
monitoring the desired utilization level and the utilization by all of the devices until utilization curtailment is no longer needed, wherein when a device reaches a value of at least one of the predefined service parameters, a command is sent to the respective premise controller of the group to signal the premise controller to restore delivery of said resource to the interrupted device.

22. The method of claim 4, wherein customer priority is based on criteria including amount of time the device has been manipulated and amount of time said resource has not been supplied to the device.

23. The method of claim 4, wherein customer preferences are based on criteria including at least one of monthly budget limits and ambient house temperature.

24. The method of claim 1, wherein an aggregated utilization of said resource is managed and dynamically limited across at least one of an entire distribution area, targeted subareas, and individual customer premises.

25. The method of claim 6, further comprising:
communicating between an enterprise management platform and the premise controllers and premise sensors in a mesh network.

26. The method of claim 25, wherein the premise controllers are controlled wirelessly via radio signals and the premise sensors transmit data wirelessly.

27. The method of claim 25, wherein the premise controllers and premise sensors are grouped together and each group communicates with the enterprise management platform via an aggregator for the group.
